(19) United States
(12) Patent Application Publication
(10) Pub. No.: US 2015/0001442 A1
(43) Pub. Date: Jan. 1, 2015

(54) METHOD FOR SYNTHESIZING AIR ELECTRODE POWDER FOR MID- AND LOW- TEMPERATURE SOLID OXIDE FUEL CELL ACCORDING TO SOL-GEL PROCESS

(71) Applicant: Korea Institute of Industrial Technology, Chungcheongnam-do (KR)

(72) Inventors: Ho Sung Kim, Suwon-shi (KR); Ju Hee Kang, Gwangju-si (KR); Hyo Sin Kim, Seoul (KR); Jin Hun Jo, Hwaseong-si (KR); Yeong Mok Kim, Daegu-si (KR); Sang Hun Heo, Changwon-shi (KR); Ik Hyun Oh, Gwangju-si (KR)

(73) Assignee: Korea Institute of Industrial Technology, Chungcheongnam-do (KR)

(21) Appl. No.: 14/377,099

(22) PCT Filed: Oct. 9, 2012
(86) PCT No.: PCT/KR2012/008149

§ 371 Date: Aug. 6, 2014

(30) Foreign Application Priority Data
Feb. 27, 2012 (KR) 10 2012 0019674

(51) Int. Cl. C01G 51/04; H01M 4/90

(52) U.S. Cl. CPC C01G 51/04; H01M 4/9033; H01M 2004/8689
USPC 252/182.1

(57) ABSTRACT

Provided is a method for synthesizing air electrode powder, which uses instead of an organic solvent lanthanum-nitrate, strontium-nitrate, cobalt-nitrate, and iron-nitrate, which are affordable and can undergo water-based synthesis, by controlling additional mol ratio and a synthesis temperature of a chelate agent and an esterification reaction accelerating agent instead of complex process controlling conditions, such as a hydrolysis condition and pH in order to control particle shape.

### TECHNICAL FIELD

The present invention relates to a solid oxide fuel cell (SOFC), and more particularly to a method of synthesizing cathode powder enabling operation at medium-low temperatures.

### BACKGROUND ART

Various types of fuel cells include a molten carbonate fuel cell (MCFC) and a solid oxide fuel cell (SOFC) that operate at high temperatures, and a phosphoric acid fuel cell (PAFC), an alkaline fuel cell (AFC), a proton exchange membrane fuel cell (PEMFC), and a direct methanol fuel cell (DEMFC) that operate at relatively low temperatures.

An SOFC is a fuel cell that uses a solid oxide electrolyte with oxygen ion conductivity and operates at a highest temperature of 900 to 1,000° C. among existing fuel cells. Also, since all elements are made of solid materials, the SOFC has a simple structure and does not experience loss and replenishment of electrode materials and corrosion generally experienced by other fuel cells. Moreover, the SOFC does not involve expensive noble metal catalysts, directly uses hydrocarbon fuel without a reformer and raises thermal efficiency up to 70% using waste heat emitted when discharging high-temperature gas. Thus, the SOFC has the highest efficiency among the existing fuel cells and enables cogeneration.

Lanthanum strontium manganite (LSM) (La_{0.7}Sr_{0.3}MnO₃) is most commonly used as a cathode material for an SOFC, is known as a representative cathode material for an SOFC due to high mechanical reliability, stability, and electrical activity under oxidation/reduction atmospheres and a similar coefficient of thermal expansion to that of Yttria-stabilized zirconia (YSZ) of an electrolyte. However, when an operating temperature of a cell is lowered, an oxygen reduction reaction becomes less active to increase overvoltage, and performance of the cell deteriorates. Conversely, La₁₋ₓSrₓCo_{y}Fe_{1-y} materials with mixed conductivity are not thermally and chemically stable, but also have a fast charge exchange reaction rate due to high oxygen ion vacancies, exhibit high catalytic properties at medium-low temperatures and thus, is expected to be a prospective alternative for a conventional LSM cathode material.

Among these materials, La_{0.6}Sr_{0.4}Co_{0.2}Fe_{0.8}O_{3-δ} is reported to have superior output characteristics in a temperature range of 600 to 800° C.

An La_{0.6}Sr_{0.4}Co_{0.2}Fe_{0.8}O_{3-δ} cathode is generally made by an expensive manufacturing device including a plasma spray. Since high electrode manufacturing costs make realizing practical use difficult, an inexpensive process such as dip coating or screen printing is required. A cathode is applied in a slurry form to a thickness of 30 to 50 micrometers (μm) to an anode supporter. A thickness of a cathode of an anode supporter-type SOFC is limited and thus, La_{0.6}Sr_{0.4}Co_{0.2}Fe_{0.8}O_{3-δ} powder is used for the cathode to increase density per unit area and to have regular pores provided in a spherical shape, a small particle size, and a large specific surface area so as to synthesize an anode material with high electrical conductivity and ion conductivity. Although various methods for synthesizing nano-size powder have been introduced, such as coprecipitation, solution combustion, spray pyrolysis, and hydrothermal synthesis, an efficient method of obtaining La_{0.6}Sr_{0.4}Co_{0.2}Fe_{0.8}O_{3-δ} cathode materials has yet to be established.

### DISCLOSURE OF INVENTION

### Technical Goals

Conventionally, a solid-state reaction is generally used to prepare perovskite powder. This method realizes excellent mass production but has difficulties in terms of controlling a composition and phase of prepared powder. Thus, a cathode powder with superior quality and perfbrmance is not produced. According to exemplary embodiments of the present invention, various methods including coprecipitation, solution combustion, spray pyrolysis, and hydrothermal synthesis are being investigated to synthesize nano-size powder.

Although such synthesis methods are effective for synthesizing nano-size powder, these methods involve complicated synthesis processes and diverse process factors. Also, due to difficulties in controlling particle shapes and sizes and managing quality without accurate control of the factors, such methods are inappropriate for a mass production system. On a cathode of an SOFC, rapid diffusion of fuel is required along with maximally increasing an area of a three-phase interface at which an electrochemical reaction occurs. Thus, technology for manufacturing nano-size regular particles using an inexpensive process with excellent reproducibility is necessary.

### Technical Solutions

According to exemplary embodiments of the present invention, there is provided a method of synthesizing a cathode powder for a solid oxide fuel cell (SOFC) which is capable of producing an La_{0.6}Sr_{0.4}Co_{0.2}Fe_{0.8}O_{3-δ} cathode material in a short time using a sol-gel process, the cathode material having nano-particles and excellent cell characteristics. Also, the method may produce a powder exhibiting excellent reproducibility, being synthesized in a short time, including fine particles and having high specific surface area by improving a conventional sol-gel process into a simple process with reduced process control factors. A method of synthesizing the cathode powder for an SOFC according to an exemplary embodiment of the present invention includes forming a mixture solution by sequentially mixing lanthanum nitrate, strontium nitrate, cobalt nitrate, and iron nitrate as a metal precursor, a chelate agent and an esterification agent, forming a metal salt/chelate complex by heating the mixture solution, forming a sol by heating the metal salt/chelate complex, forming a gel precursor by heating the sol, and forming nano-La_{0.6}Sr_{0.4}Co_{0.2}Fe_{0.8}O_{3-δ} cathode powder by firing the gel precursor.

The chelate agent is any one selected from citric acid (C₆H₈O₇) and glycolic acid (C₂H₄O₃), and the esterification catalyst is ethylene glycol. The metal precursor and the chelate agent are mixed at a mole ratio of 1:2, and a chelate complex and the esterification agent are mixed at a mole ratio of 1:1. The metal precursor includes a mixture of La(NO₃)₃·6H₂O, Sr(NO₃)₂, Co(NO₃)₂6H₂O and Fe(NO₃)₃·9H₂O at a mole ratio of 3:2:1:4.

The forming of the metal salt/chelate complex includes heating the mixture solution placed in a reactor for 2 hours using a hot plate. The forming of the sol includes heating the metal salt/chelate complex at a rate of 5° C./hr in a temperature range of 60 to 80° C. into a polymer. The forming of the sol includes heating the metal salts/chelate complex using the hot plate after gradually elevating temperature at a rate of 5° C./hr from 60 to 80° C. The forming of the gel precursor includes maintaining the sol at 100° C. for a predetermined time into the gel precursor. The forming of the gel precursor includes heating the sol at a constant temperature using a heating mantle and stirring the sol at a constant speed using a stirrer.

The forming of the powder includes heating the gel precursor at 400° C. and heat-treating the gel precursor at 800° C. in a furnace in an air atmosphere. Effects of the Invention

As described above, exemplary embodiments of the present invention provide a method of preparing a La_{0.6}Sr_{0.4}Co_{0.2}Fe_{0.8}O_{3-δ} nano-cathode powder which enables excellent output characteristics of a solid oxide fuel cell (SOFC) at medium-low temperatures by synthesizing a La_{0.6}Sr_{0.4}Co_{0.2}Fe_{0.8}O_{3-δ} cathode powder using an improved conventional sol-gel process.

The preparing method of the present invention may produce a high-quality La_{0.6}Sr_{0.4}Co_{0.2}Fe_{0.8}O_{3-δ} powder through a simple process. The preparing method is cost-efficient and easy, and has simple process control factors, as compared with conventional ceramic powder synthesis methods including coprecipitation and combustion spray pyrolysis and thus, is appropriate for practical mass production. The La_{0.6}Sr_{0.4}Co_{0.2}Fe_{0.8}O_{3-δ} powder prepared by the foregoing method includes uniform and fine spherical particles with a porous structure, and has good qualities such as excellent electrical conductivity due to an accurately controlled composition. Thus, the powder is useful as a cathode material for an SOFC.

### BRIEF DESCRIPTION OF DRAWINGS

FIG. 1 is a flowchart illustrating a process of preparing a La_{0.6}Sr_{0.4}Co_{0.2}Fe_{0.8}O_{3-δ} powder.

FIG. 2 is a diagram illustrating an apparatus for preparing the La_{0.6}Sr_{0.4}Co_{0.2}Fe_{0.8}O_{3-δ} powder.

FIG. 3 is a graph illustrating an X-ray diffraction pattern of the La_{0.6}Sr_{0.4}Co_{0.2}Fe_{0.8}O_{3-δ} powder.

FIG. 4 is a table analyzing a structure of the La_{0.6}Sr_{0.4}Co_{0.2}Fe_{0.8}O_{3-δ} powder.

FIG. 5 is a table illustrating electrical conductivity of the La_{0.6}Sr_{0.4}Co_{0.2}Fe_{0.8}O_{3-δ} powder.

### BEST MODE FOR CARRYING OUT THE INVENTION

While exemplary embodiments of the present invention will be described below in detail with reference to the accompanying drawings, the present invention is not limited to the exemplary embodiments. In describing the present invention, detailed descriptions of known functions or configurations may be omitted so as to clarify the gist of the present invention.

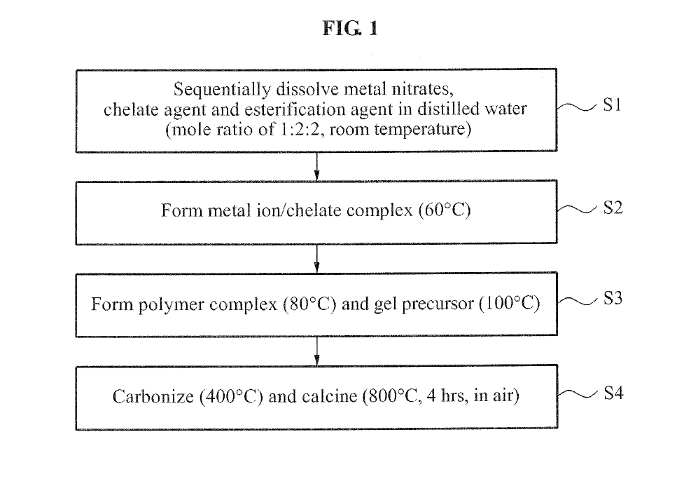

Hereinafter, a method of synthesizing cathode powder for a solid oxide fuel cell (SOFC) according to an exemplary embodiment of the present invention will be described in detail with reference to FIGS. 1 to 5.

In order to control a particle shape, a cathode powder is synthesized using affordable materials that allow water-based synthesis, rather than synthesis with an organic solvent, such as lanthanum nitrate, strontium nitrate, cobalt nitrate and iron nitrate as metal precursors by controlling a mole ratio between a chelate agent and an esterification agent and synthesis temperature, instead of controlling complicated process conditions including hydrolysis conditions and pH.

Here, the chelate agent is selected from citric acid (C₆H₈O₇) and glycolic acid (C₂H₄O₃), and the esterification agent is ethylene glycol. A mole ratio between the chelate agent and all metal ions is 1:2, while a mole ratio between a chelate complex and ethylene glycol is 1:1. Further, the chelate/metal ion complex is formed at 60° C., and the complex compound-polymer complex is formed by gradually elevating temperature to 80° C. at a rate of 5° C./hr. The sol obtained by controlling the mole ratios and temperatures according to the foregoing process reinforces a bonding structure of the metal salts and the chelate agent to increase a yield and uniformly distributes and fixes metal cations to prepare fine and homogeneous powder.

The process of preparing the La_{0.6}Sr_{0.4}Co_{0.2}Fe_{0.8}O_{3-δ} power is described in detail as follows.

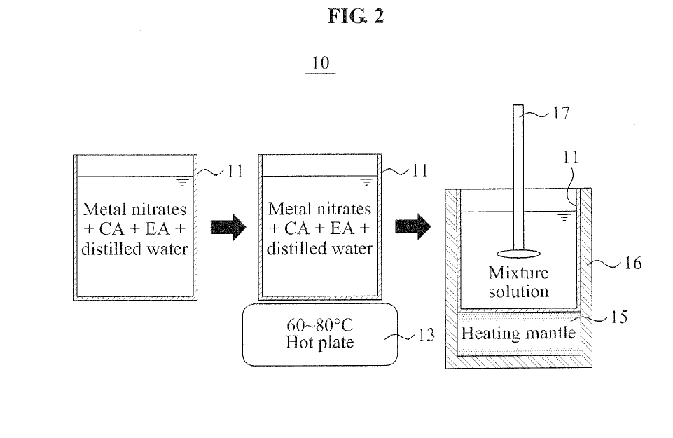

FIG. 1 is a flowchart illustrating the process of preparing the La_{0.6}Sr_{0.4}Co_{0.2}Fe_{0.8}O_{3-δ} powder, and FIG. 2 is a diagram illustrating an apparatus for preparing the La_{0.6}Sr_{0.4}Co_{0.2}Fe_{0.8}O_{3-δ} powder. The apparatus 10 includes a reactor 11 for dissolving the metal nitrates, a chelate agent (CA), an esterification agent (EA) and distilled water, a hot temperature 13 for raising temperature, a heating container 16 accommodating a heating mantle 15 for maintaining temperature, and a stirrer 17.

The metal nitrates are dissolved in distilled water first, and the CA and the EA are sequentially added to the distilled water (S1).

Specifically, as shown in FIG. 2, La(NO₃)₃·6H₂O, Sr(NO₃)₂, Co(NO₃)₂6H₂O and Fe(NO₃)₃·9H₂O are dissolved at a mole ratio of 3:2:1:4 in the reactor 11 containing distilled water at room temperature, and the CA and the EA are sequentially added thereto according to the foregoing mole ratios. Here, the chelate agent is any one selected from citric acid (C₆H₈O₇) and glycolic acid (C₂H₄O₃), and the esterification agent is ethylene glycol.

The reactor 11 is heated at 60 to 80° C. for 2 hours using the hot plate 13 to form a stable metal ion/chelate complex (S2).

The metal ion/chelate complex is heated after gradually elevating temperature from 60 to 80° C. at a rate of 5° C./hr, thereby forming a sol as a polymer complex.

The sol is left at 100° C. for a predetermined time to form a porous gel precursor of orange color (S3). Here, to form the gel precursor, the polymer complex is stirred at a constant speed and a constant temperature using the stirrer 17 in the reactor 11, maintaining the constant temperature using the heating mantle 15 under the reactor 11. Here, in order to form the mixture solution in the reactor 11 into the sol, then into a gel to carbonize, the reactor 11 is accommodated in the heating container 16 and the heating mantle 15 is disposed under the reactor 11 in the heating container 15, thereby heating the sol at the constant temperature while maintaining the temperature.

The gel precursor is heated at 400° C. to self-combust to ash to be carbonized, followed by calcination of conducting heat treatment at 800° C. for 4 hours in a furnace in an air atmosphere, thereby obtaining a final oxide (S4).

The process of synthesizing the nano-size powder according to the exemplary embodiment of the present invention may produce spherical fine porous nano-powder with excellent electrical conductivity using a sol-gel process that is simple and fast and facilitates mass production. A cathode manufactured using this nano-powder has uniform distribution of pores and thus, obtains optimal properties through the pores to reduce polarization resistance of the cathode. Moreover, a three-phase interface where an electrochemical reaction occurs is expanded and electron and ion conductivity is excellent, thereby improving output performance. In addition, using dip coating or screen printing, a cathode is manufactured by uniform and continual application to a limited area, in which case when this powder is employed, the cathode has a high density per unit area and uniform distribution of pores, so that a surface charge exchange with oxygen transpires rapidly so as to remarkably reduce polarization resistance.

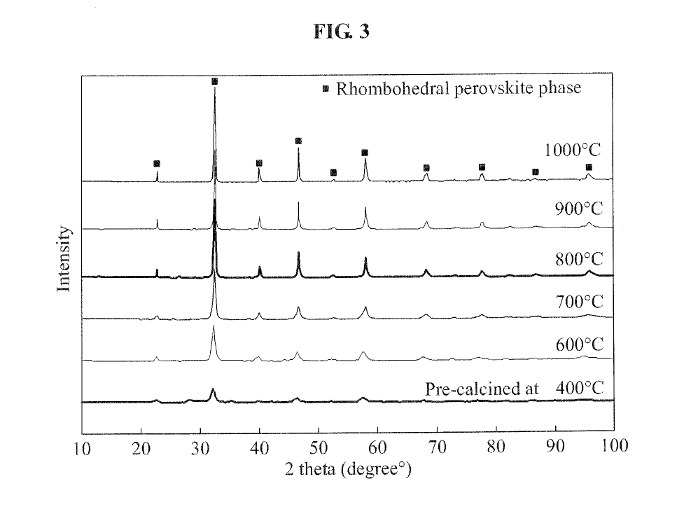

FIG. 3 illustrates a result of analyzing an X-ray diffraction (XRD) pattern of the La_{0.6}Sr_{0.4}Co_{0.2}Fe_{0.8}O_{3-δ} powder according to the synthesis method of the present invention, showing an XRD pattern of powder as a final byproduct obtained via heat treatment in a temperature range of 600 to 1,000° C. for 4 hours. Despite an increase in calcining temperature, a secondary phase does not appear and a clear single phase is formed from 700° C. As heat treatment temperature rises, intensity of a peak tends to increase, and peaks at all angles tend to be stabilized at 800° C. or higher.

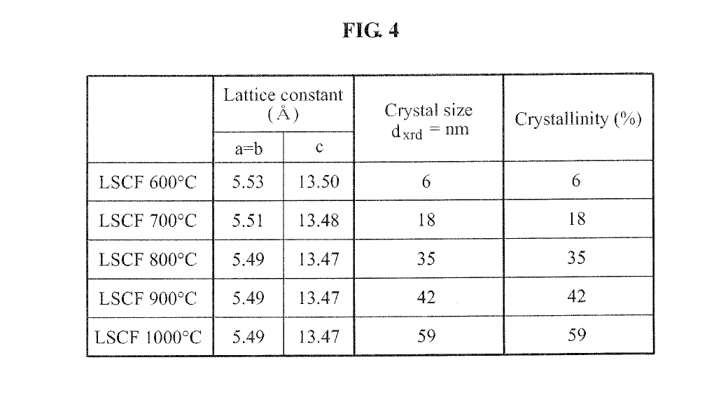

FIG. 4 illustrates a result of analyzing a structure of the La_{0.6}Sr_{0.4}Co_{0.2}Fe_{0.8}O_{3-δ} powder. As a result of analyzing a lattice constant of the calcined powder at each temperature, the synthesized powder has a rhombohedral perovskite phase of an R-3C space group, and the constant lattice of the powder is the same from 800° C. Accordingly, it is proved that even at a comparatively low temperature of 700° C. the powder is synthesized with a nano-size and the synthesis method of the present invention produces a quality powder with excellent crystallinity. The powder prepared by the method of the present embodiment is a spherical fine porous powder, particularly a comparatively spherical La_{0.6}Sr_{0.4}Co_{0.2}Fe_{0.8}O_{3-δ} cathode powder with a nano-size of 50 nanometers (nm) to 100 nm as a result of analyzing a size and shape of crystal particles.

### Example

Electrical conductivity was measured using the La_{0.6}Sr_{0.4}Co_{0.2}Fe_{0.8}O_{3-δ} powder prepared by the synthesis method of the embodiment of the present invention. A sample was made by uniaxial pressing, in which the powder was put in a circular mode, pressed at 49 megapascals (MPa) for 3 hours, sintered at 1,100° C. for 7 hours, and processed into a shape of a rectangular cuboid, thereby obtaining the sample for measuring electrical conductivity.

The electrical conductivity of the La_{0.6}Sr_{0.4}Co_{0.2}Fe_{0.8}O_{3-δ} powder was evaluated as follows.

The electrical conductivity of the obtained sample was measured under a temperature elevating atmosphere and a cooling atmosphere in an operating temperature range of 700 to 800° C. by a DC 2-prove method using an electrical conductivity meter to calculate an average value.

### Comparative Example

Electrical conductivity was evaluated using commercially available powder (from P company) synthesized by combustion spray pyrolysis in the same manner as used in the example.

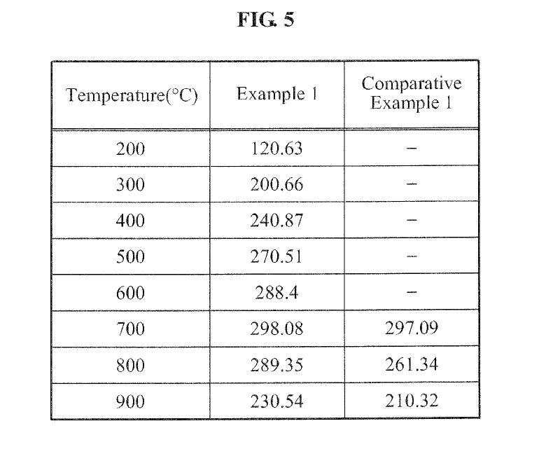

As a result of measuring electrical conductivity in the example and the comparative example, the example shows an excellent electrical conductivity of 298 siemens/centimeter (S/cm). Here, FIG. 5 illustrates results of measuring the electrical conductivities of the cathode powder according to the example and the electrical and the commercially available powder synthesized by combustion spray pyrolysis according to the comparative example.

Referring to FIG. 5, the cathode powder according to the example has superior electrical conductivity to that of the commercially available La_{0.6}Sr_{0.4}Co_{0.2}Fe_{0.8}O_{3-δ} powder synthesized by combustion spray pyrolysis.

Thus, La_{0.6}Sr_{0.4}Co_{0.2}Fe_{0.8}O_{3-δ} prepared according to the present invention exhibits excellent powder properties and high electrical conductivity. Further, the powder with such superior properties enables manufacture of an SOFC end cell having excellent output performance when applied to a cathode.

The present invention may provide a method of preparing the La_{0.6}Sr_{0.4}Co_{0.2}Fe_{0.8}O_{3-δ} nano-powder enabling excellent output characteristics of an

SOFC at medium-low temperature by synthesizing the La_{0.6}Sr_{0.4}Co_{0.2}Fe_{0.8}O_{3-δ} cathode powder using an improved sol-gel process. Specifically, in a conventional sol-gel process, metal powder is prepared by a method of continuously heating a sol solution at a constant temperature of 70° C. or higher to be transformed into a gel precursor for stabilizing and maintaining a bond between a metal salt and a chelate agent so as to increase a yield. However, such a method involves a long process time and difficulty in optimizing conditions based on scale. According to the present invention, when the metal salts-chelate complex is formed into the polymer complex by adding the EA and heating in a temperature range of 60 to 80° C. while elevating temperature at a rate of 5° C./hr, structural stability of the metal salts-chelate complex is good, and accordingly a process of transforming the sol solution into the gel precursor, that is, a solvent volatilizing process of continuously heating at a constant temperature and a constant stirring speed, may take less time to reduce process costs. Thus, as shown in the apparatus for preparing the La_{0.6}Sr_{0.4}Co_{0.2}Fe_{0.8}O_{3-δ} powder of FIG. 2, even though a high-speed mechanical stirrer is used for quick evaporation of the solvent in the solvent volatilizing process, the complex is not broken, thereby preparing quality powder with an accurate composition and a high yield while considerably reducing process time.

The preparing method of the present invention may produce a high-quality La_{0.6}Sr_{0.4}Co_{0.2}Fe_{0.8}O_{3-δ} powder through a simple, cost-efficient process that has simple process control factors, as compared with conventional ceramic powder synthesis methods including coprecipitation and combustion spray pyrolysis. Thus, the powder may he appropriate for practical mass production. The La_{0.6}Sr_{0.4}Co_{0.2}Fe_{0.8}O_{3-δ} powder prepared by the foregoing method includes uniform and fine spherical particles with a porous structure and has good qualities such as excellent electrical conductivity due to an accurately controlled composition and thus, is useful as a cathode material for an SOFC.

Although the present invention has been described with reference to a few embodiments and the accompanying drawings, such embodiments are provided for ease of understanding and the present invention is not limited to the foregoing embodiments. Instead, it would be appreciated by those skilled in the art that changes may be made to these embodiments without departing from the principles and spirit of the invention, the scope of which is defined by the claims and their equivalents.

What is claimed is:

1. A method of synthesizing cathode powder for a solid oxide fuel cell (SOFC), the method comprising:
forming a mixture solution by sequentially mixing lanthanum nitrate, strontium nitrate, cobalt nitrate, and iron nitrate as a metal precursor, a chelate agent and an esterification agent;
forming a metal salt/chelate complex by heating the mixture solution;
forming a sol by heating the metal salt/chelate complex;
forming a gel precursor by heating the sol; and
forming nano-La_{0.6}Sr_{0.4}Co_{0.2}Fe_{0.8}O_{3-δ} powder by firing the gel precursor.

2. The method of claim 1, wherein the chelate agent is any one selected from the group consisting of citric acid (C₆H₈O₇) and glycolic acid (C₂H₄O₃), and the esterification catalyst is ethylene glycol.

3. The method of claim 1, wherein the metal precursor and the chelate agent are mixed at a mole ratio of 1:2, and a chelate complex and the esterification agent are mixed at a mole ratio of 1:1.

4. The method of claim 1, wherein the metal precursor comprises a mixture of La(NO₃)₃·6H₂O, Sr(NO₃)₂, Co(NO₃)₂6H₂O and Fe(NO₃)₃·9H₂O at a mole ratio of 3:2:1:4.

5. The method of claim 1, wherein the forming of the metal salt/chelate complex comprises heating the mixture solution placed in a reactor for 2 hours using a hot plate.

6. The method of claim 5, wherein the forming of the sol comprises heating the metal salts/chelate complex at a rate of 5° C./hr in a temperature range of 60 to 80° C. into a polymer.

7. The method of claim 6, wherein the forming of the sol comprises heating the metal salt/chelate complex using the hot plate after gradually elevating temperature at a rate of 5° C./hr from 60 to 80° C.

8. The method of claim 1, herein the forming of the gel precursor comprises maintaining the sol at 100° C. for a predetermined time into the gel precursor.

9. The method of claim 8, wherein the forming of the gel precursor comprises heating the sol at a constant temperature using a heating mantle and stirring the sol at a constant speed using a stirrer.

10. The method of claim 1, wherein the forming of the powder comprises heating the gel precursor at 400° C. and heat-treating the gel precursor at 800° C. in a furnace in an air atmosphere.
